(19) United States
(12) Patent Application Publication
(10) Pub. No.: US 2006/0140821 A1
(43) Pub. Date: Jun. 29, 2006

(54) Powder X-ray diffraction sample holder

(76) Inventors: Victor W. Rosso, East Windsor, NJ (US); Anne I. Song, Fairfield, NJ (US); John J. Venit, North Brunswick, NJ (US); Xiaotian S. Yin, Plainsboro, NJ (US)

Correspondence Address: LOUIS J. WILLE;BRISTOL-MYERS SQUIBB COMPANY, PATENT DEPARTMENT, P O BOX 4000, PRINCETON, NJ, 08543-4000, US

(21) Appl. No.: 11/300,851

(22) Filed: Dec. 15, 2005

Related U.S. Application Data
(60) Provisional application No. 60/637,165, filed on Dec. 17, 2004.

(51) Int. Cl. B01L 9/00

(52) U.S. Cl. 422/102

(57) ABSTRACT

A laboratory sample plate for use in PXRD and other testing techniques includes a quartz body having substantially planar top and bottom surfaces that are parallel with each other. The quartz body includes a matrix of cylindrical apertures that are substantially perpendicular to the top and bottom surfaces. Each aperture has an upper opening at the top surface and a lower opening at the bottom surface of the plate body. A synthetic quartz bottom sheet is fused to the bottom surface of the quartz body. The quartz bottom sheet include respective portions that close the lower opening of each aperture in the quartz body, such that each aperture and respective portion of the bottom sheet together form a well for receiving a sample. Each aperture and respective portion of the bottom sheet are suitably dimensioned to perform a powder X-ray diffraction technique as well as microscopy and Raman spectroscopy on a sample contained in the well.

This application claims priority from U.S. Provisional Application No. 60/637,165, filed Dec. 17, 2004, incorporated herein in its entirety by reference.

### BACKGROUND OF THE INVENTION

1. Field of the Invention

The present invention relates to improvements in the field of systems for analyzing the crystalline physical and chemical forms of pharmaceutical compounds, and more specifically to a sample holder that is suitable for use in powder X-ray diffraction, as well as microscopy and Raman spectroscopy.

2. Description of Prior Art

As used herein, the term “pharmaceutical compound(s)” should be construed broadly to include any organic or inorganic molecule that may be crystalline. With respect to pharmaceutical research, the term includes, but is not limited to, any active pharmaceutical ingredient (API), final intermediate (AKA penultimate intermediate), pivotal intermediate, isolated intermediate, protein, deoxyribonucleic acid (DNA), ribonucleic acid (RNA), amino acid, polypeptide, fermentation product, complex and starting material, regardless of its source (natural, unnatural or semi-synthetic). The term “pharmaceutical compound(s)” includes colloquial references, including but not limited to large molecules, small molecules, neutral molecules, semi-synthetic molecules, or biological (or fermentation) molecules. The term also includes any compound that may be used in the synthesis of a pharmaceutical.

Potential drug candidates include organic and inorganic molecules, which may crystallize in one of several different forms, or a mixture of these forms. Different physical forms (polymorphs) and chemical forms (salt forms, solvates, and complexes) of a compound can have significantly different physiochemical properties. In some instances, the different physiochemical properties (e.g., solubility, melting point, etc.) can lead to differences in bioavailability in preclinical and clinical testing.

The crystallization parameters that influence the solid state form of any compound include temperature, reaction time, pH, concentration of the compound of interest in a solvent or solvents and concentration of impurities in a solvent or solvents. Additional crystallization parameters that influence the solid state form of any compound include seeding or lack thereof, nucleation rate, precipitation rate, crystallization rate, saturation point, and solubility with respect to temperature. Additionally, the rate of adjustment of any or all of the aforementioned parameters, as well as the type and composition of the solvent used, will influence the solid state form. Henceforth, the polymorphs, solvates, complexes and salt forms of compounds will be referred to as “forms” for simplicity.

Identification of an optimal form of a compound is one of the key requirements for successful pharmaceutical development. Further, it is important to determine which polymorphic form of the compound is produced by a particular set of parameters in order to formulate the optimum protocol for producing the compound. It is therefore critical to have a means of analyzing arrays of solids for their crystalline properties.

One common diagnostic method for identifying the crystalline forms of a compound is X-ray diffraction. Because the atomic coordinates of each polymorph are different, each polymorph's crystal will diffract X-rays in a distinctive pattern. Typically, the samples screened in pharmaceutical development are a collection of randomly oriented crystallites that form a powder. For that reason, the technique is commonly referred to as “powder X-ray diffraction” (PXRD).

The X-ray diffraction from a crystalline powder sample generates a certain pattern. Typical PXRD instruments designed for laboratory use are capable of measuring a powder diffraction pattern from approximately 100-500 mgs of material. The pattern is measured by scanning a sample with an X-ray beam and at the same time scanning a detector that measures the intensity of radiation diffracted by the sample as a function of the diffracting angle. The pattern of the diffracted radiation received at the detector is characteristic of the sample. Since each crystalline structure dictates a unique pattern, it is possible to distinguish among different forms of the compound present in the sample by analyzing the diffraction pattern.

Often, a compound will exist in several different polymorphic crystalline forms. It is important to test a variety of crystallization conditions to ensure that all polymorphs that can be produced are identified, and to optimize the crystallization conditions that produce polymorphs and salts with desired physical properties.

The identification of polymorphs may require a large number of samples to be screened using high-throughput crystallization (HTC) techniques. In addition to PXRD, other techniques are used to analyze the properties of pharmaceutical compounds, including microscopy and Raman spectroscopy. Each technique has its particular advantages and commonly all three techniques are used to generate a comprehensive set of analytical data.

However, where microscopy, Raman spectroscopy, and PXRD are all used in analyzing a pharmaceutical compound, the preparation of PXRD samples typically creates a bottleneck. Samples for microscopy and Raman spectroscopy may suitably be held in a 96-well plate, and the same plate may be used for both techniques. The 96 wells in the sample plate are arranged in a rectangular matrix, and an automated system using two-dimensional X-Y or Cartesian coordinates may be incorporated to allow detection and analysis of the samples contained in each well in the matrix.

Prior art 96-well plates, however, have been found to be unsuitable for use in PXRD. Thus, samples held in a 96-well plate must be transferred onto a suitable PXRD sample holder or, alternatively, fresh samples of the pharmaceutical compound must be prepared for use in PXRD. In addition to increasing the amount of time required to analyze a new pharmaceutical, transferring samples or preparing additional samples increases the risk of human error. Also, new pharmaceuticals are typically prepared in very small quantities, and it is therefore highly desirable to use as little of the pharmaceutical as possible for testing purposes.

### SUMMARY OF THE INVENTION

To address such issues and others, an aspect of the invention provides a sample plate for use in PXRD and other testing techniques. The plate comprises a quartz body having substantially planar top and bottom surfaces that are parallel with each other. The quartz body includes a matrix of cylindrical apertures that are substantially perpendicular to the top and bottom surfaces. Each aperture has an upper opening at the top surface and a lower opening at the bottom surface of the plate body. A synthetic quartz bottom sheet is fused to the bottom surface of the quartz body. The quartz bottom sheet includes respective portions that close the lower opening of each aperture in the quartz body, such that each aperture and respective portion of the bottom sheet together form a well for receiving a sample. Each well is suitably dimensioned to allow a powder X-ray diffraction technique to be performed on a sample contained therein.

Additional features and advantages of the present invention will become apparent by reference to the following detailed description and accompanying drawings.

### BRIEF DESCRIPTION OF THE DRAWINGS

FIG. 1 shows an elevation view of a sample plate according to a first aspect of the invention.

FIG. 2 shows an exploded side view of the sample plate shown in FIG. 1.

FIG. 3 shows an isometric view of an individual well in the sample plate shown in FIG. 1.

FIG. 4 shows a table setting forth polishing standards for plates of the type shown in FIG. 1.

FIG. 5 shows a table setting forth an exemplary series of solutions used to test plates of the type shown in FIG. 1.

FIG. 6 shows a table setting forth an exempary loading of samples of test solutions into plates of the type shown in FIG. 1.

FIG. 7 is a graph showing Raman spectra for samples contained in a plate of the type shown in FIG. 1.

FIGS. 8-15 are a series of graphs showing PXRD test results for plates of the type shown in FIG. 1.

FIG. 16 is a flowchart showing a method for testing samples according to a further aspect of the invention.

FIG. 17 is a flowchart showing a method for preparing a powder sample from a pharmaceutical compound in slurry form.

### DETAILED DESCRIPTION OF THE INVENTION

An aspect of the present invention provides a 96-well quartz plate for use in high throughput crystallization (HTC) workflow. As discussed in detail below, a plate according to the present invention is suitable for collecting powder X-ray diffraction (PXRD) patterns. The collected PXRD data exceeds acceptable minimums for resolution and intensity. Although multi-well quartz sample plates have been used in other applications, they have been considered to be unsuitable for direct use in PXRD because of the physical properties of quartz and because of the requirements for preparing a suitable PXRD sample.

Using a plate according to the present invention, it is possible to perform screening experiments on samples loaded into wells in the plate and then collect critical analytical data, including birefringence, Raman spectra, and PXRD, which can identify solids in the wells as leads for active pharmaceutical ingredient (API) final form and polymorph studies. The present invention eliminates sample filtration and transfer steps. Also, a plate according to the present invention may be used to conduct slurry studies including relative stability study of forms and transition point study of solvates.

Thus, overall productivity is increased by minimizing sample preparation time and minimizing the amount of sample needed to gain the maximum knowledge of solids, including birefringence, chemical identification and composition of salts, and polymorphism of crystalline samples (hits) obtained through HTC. This solid characterization capability enables an investigator to make more data-driven decision on hits for scale up studies. Currently, Raman spectroscopy is used for chemical identification of HTC hits, for example, by comparing API vs. counter ions, and other such techniques. Using Raman spectra data, polymorphs often show only subtle differences, which can make polymorph screening in form selection a challenging process. Typically, PXRD pattern data can be grouped more effectively than Raman spectra.

Collecting PXRD pattern data at early stages of drug development can also utilize the simulated patterns obtained from single crystal work completed at the discovery stage to make the HTC product identification easier. In a competitive industry, it is desirable to be able to collect all these analytical data from a single sample plate at a very early stage of API form screening.

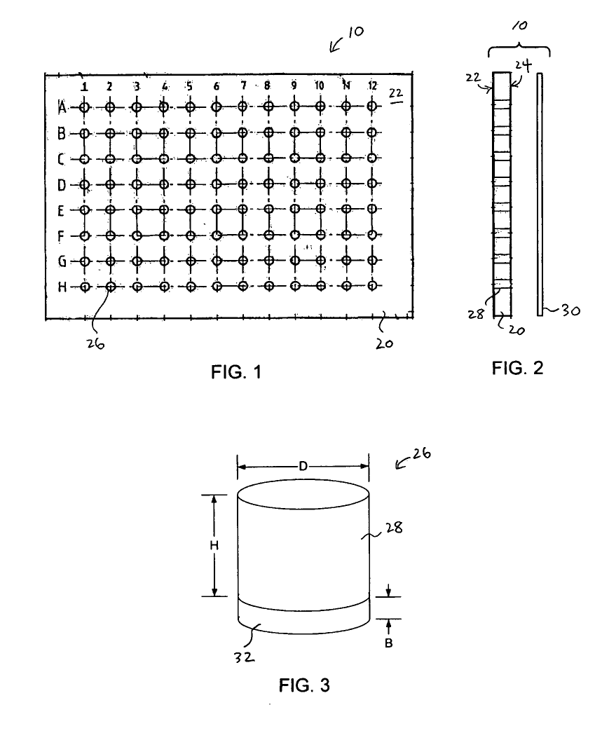

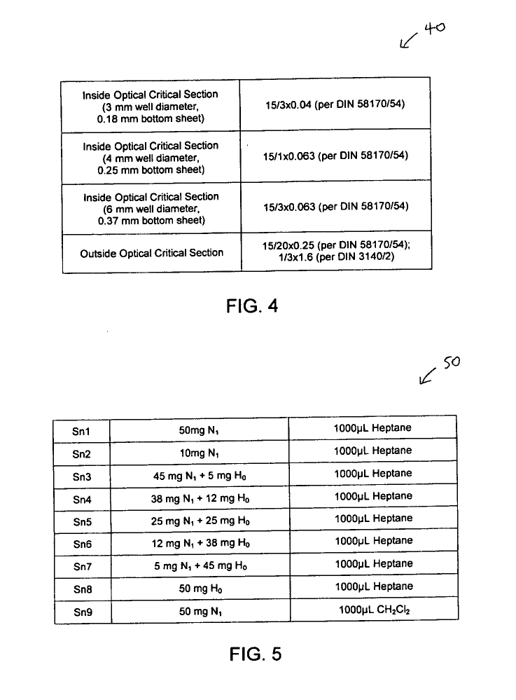

FIG. 1 shows a top view of a PXRD plate 10 according to a first aspect of the invention, and FIG. 2 shows an exploded side view of the plate 10. As shown in FIGS. 1 and 2, the plate 10 includes a body 20 and a bottom sheet 30, not drawn to scale, that is fabricated from synthetic quartz. Quartz has been found to be superior to glass because quartz minimizes background fluorescence. The body 20 is substantially flat and has an upper surface 22 and a lower surface 24 that are substantially parallel with each other.

As shown in FIG. 1, the plate 10 includes a plurality of cylindrical wells 26 for holding samples. These wells 26 are formed in the following manner. As shown in FIG. 2, the plate body 20 includes a matrix of cylindrical apertures 28 having respective openings at the plate body's upper and lower surfaces 22 and 24. The apertures 28 may be formed by drilling or other suitable technique. The cylindrical apertures 28 are substantially perpendicular to the upper and lower surfaces 22 and 24. The bottom sheet 30 is fused to the lower surface of the plate body 20. The bottom sheet 30 includes respective portions that close up the bottom openings of each aperture 28 in the plate body 20 to form individual wells 26.

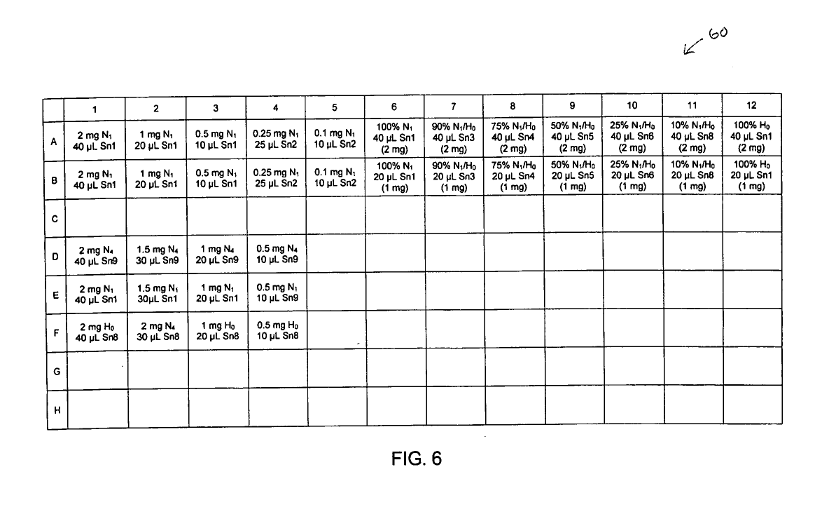

FIG. 3 shows an isometric view of an individual well 26, not drawn to scale. The well 26 includes a cylindrical aperture 28 formed in the plate body 20 and a portion 32 of the bottom sheet 30. As discussed below, the height H and diameter D of the aperture 28 and the thickness B of the bottom sheet 32 are important parameters in achieving a sample plate 10 that is suitable for PXRD and other testing techniques.

Specifically, it has been found that an ultrathin bottom sheet 30 produces acceptable results. As discussed below, where the height H of each well 26 is 6 mm, suitable thicknesses B for the bottom sheet 30 have been found to include 0.18 mm, 0.25 mm, and 0.37 mm. Different well diameters D are used for each bottom thickness. For the 0.18 mm bottom, 3 mm was found to be a suitable well diameter. For the 0.25 mm bottom, 4 mm was found to be a suitable well diameter. For the 0.37 mm bottom, 6 mm was found to be a suitable well diameter. The minimum bottom thickness of each plate is governed by the well diameter to ease the tension at the bottom. It should be noted that these dimensions are exemplary, and it is not intended to limit the invention to these dimensions. For the purposes of the following discussion, the three plates are respectively referred to as the “0.18 mm plate,” the “0.25 mm plate,” and the “0.37 mm plate.” The respective volumes of the individual wells in each plate are 41 μL, 72 μL and 159 μL.

As illustrated in FIG. 1, and as discussed above, the wells 26 in the plate 10 are arranged in an 8×12 matrix. The plate includes letters and numbers that are used to identify individual cells in the matrix. As shown in FIG. 1, the columns of the matrix are labeled 1-12. The rows in the matrix are labeled A-H. Each cell in the matrix is uniquely identified by a row letter and a column number.

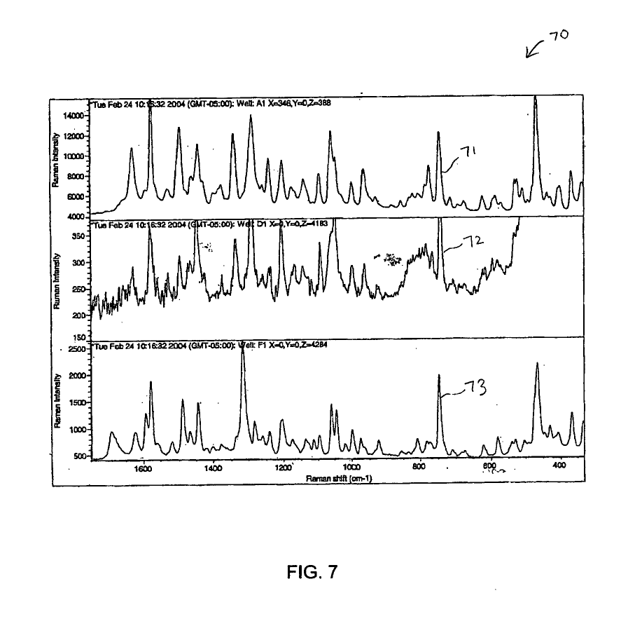

As part of the fabrication process, the plate 10 is polished to a suitable optical standard. FIG. 4 shows a table 40 setting forth suitable optical standards for the 0.18 mm, 0.25 mm and 0.37 mm plates. All edges of the plate 10 are chamfered.

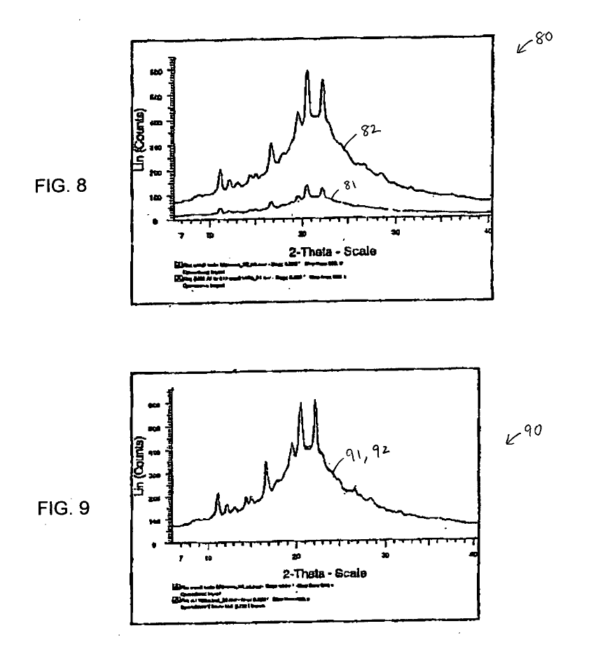

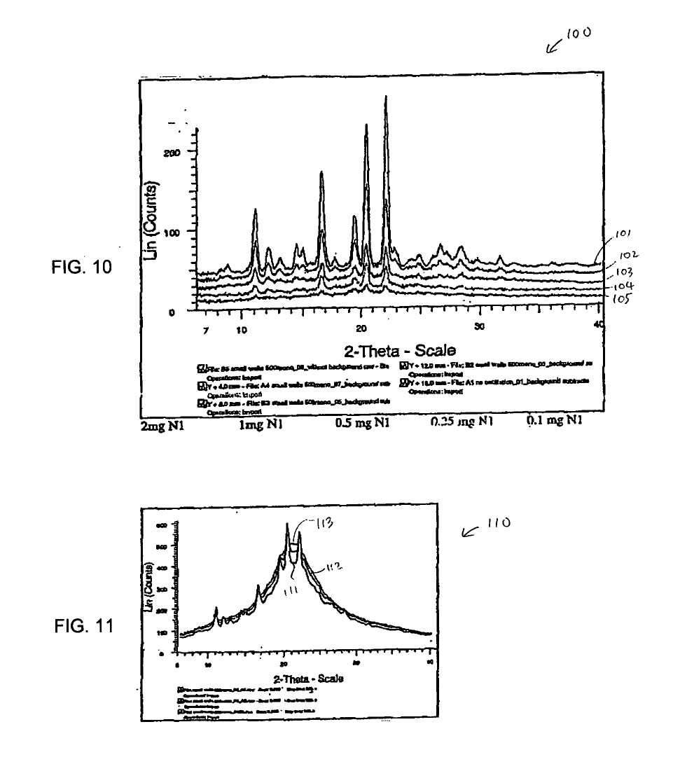

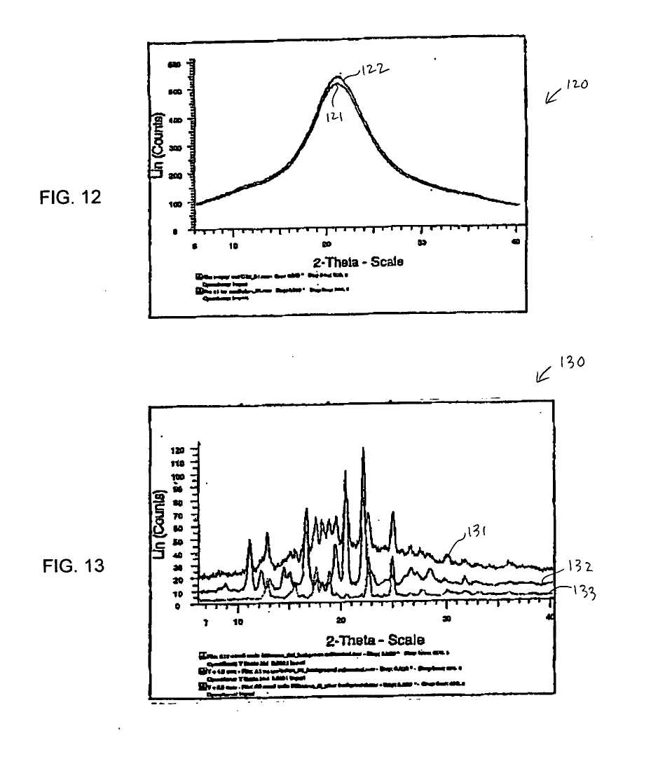

Initial tests were performed on the 0.18 mm, 0.25 mm, and 0.37 mm plates using as samples the N₁, H₀, and N₄ forms of Aripiprazole. FIG. 5 shows a table 50 setting forth a series of nine solutions Sn1-Sn9 that were prepared for these tests. The three plates were identically loaded, in accordance with the table 60 set forth in FIG. 6. Each cell in the table 60 corresponds to an individual well in each plate. Samples were loaded into 36 wells, with 60 wells remaining empty. The plates were initially tested using Raman spectroscopy. Raman spectra for the 0.37 mm plate are set forth in the graph 70 shown in FIG. 7. The top trace 71 shows the Raman spectrum for cell A1, the middle trace 72 shows the Raman spectrum for cell D1, and the bottom trace 73 shows the Raman spectrum for cell F1.

The three plates were then tested using a powder X-ray diffractometer, the Bruker AXS CST system. Initial evaluation of the plates determined that only a 15 degree, two theta range data, half of that expected, was offered by the 0.18 mm plate due to shading. As a corrective measure, the Bruker instrument was used in an inverted configuration, with the X-ray tube on top and the detector below the sample library to avoid shading by the sample plate. The sample-detector distance was 15 cm. An incident beam graphite monochromator was used at 40 kV, 50 mA.

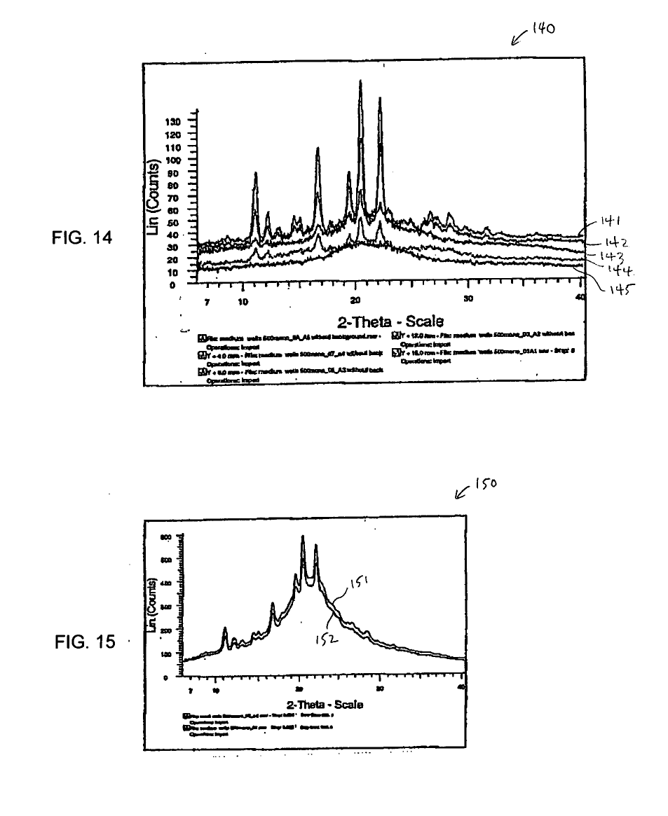

A first series of tests was conducted to determine an optimum source accessory for the Bruker instrument. No angle opening problem was observed. Three source accessories were subjected to comparison testing to determine which accessory achieved the best combination of intensity (signal to noise ratio) and resolution: a 500 μm collimator, a 500 μm monocap, and a 300 μm monocap. The results of these tests are shown in FIGS. 8 and 9.

FIG. 8 shows a graph 80 comparing the results obtained using the 500 μm collimator and the 500 μm monocap on the sample in well A1 on the 0.18 mm plate. The 500 μm collimator is represented by the lower trace 81 in the graph 80, and the 500 μm monocap is represented by the upper trace 82. As shown in FIG. 8, the monocap yields peaks that are significantly stronger than those of the collimator.

FIG. 9 shows a comparison between a first trace 91 showing results obtained using a 300 μm monocap and a second trace 92 showing the results obtained using the 500 μm monocap. In the graph, the 300 μm monocap trace 91 is scaled by a factor of approximately 2.8. With scaling, the two traces 91 and 92 are substantially identical. Thus, it will be seen from FIG. 9 that the 500 μm monocap yielded an intensity of approximately 2.8 times greater than that of the 300 μm monocap, with nearly identical resolution. Therefore, all subsequent measurements were made using the 500 μm monocap.

In order to determine an optimal sample amount, a study was conducted using the 0.18 mm plate to test the samples in wells A1, B2, B3, A4 and B5. These wells contained the following respective amounts of the N₁ form of Aripiprazole: 2 mg, 1 mg, 0.5 mg, 0.25 mg, and 0.1 mg. The results of the study are shown in FIG. 10. The highest trace 101 corresponds to A1. Each successively lower trace 102-105 corresponds to the next sample column. According to the results, the minimum acceptable sample amount appears to be 0.25 mg, corresponding to trace 104.

One issue encountered during the comparison testing was a difference in background counts in the samples. It was found that the total count rate over the whole range decreased with increased sample amounts. The decrease in total count rate is illustrated in FIG. 11, which shows a graph 110 of the results from samples B1, B2 and B3, measured with a 500 μm monocap, after background subtraction. Trace 111 corresponds to sample B1 (2 mg), trace 112 corresponds to sample B2 (1 mg), and trace 113 corresponds to sample B3 (0.5 mg).

As shown in FIG. 11, the background appears to increase as the sample amount decreases. One possible explanation for this increase in background is light absorption by the samples, leading to different amounts of light actually hitting the quartz bottom sheet. Another explanation is a possible variation in the thickness of the bottom sheet in the plate, leading to wells having different bottom thicknesses. This possibility was examined by scanning two empty wells (C1 and C2) of the 0.18 mm plate. The result of this comparison is shown in the graph 120 in FIG. 12. The lower trace 121 corresponds to well C1, and the upper trace 122 corresponds to well C2. It will be seen in graph 120 that the two traces 121 and 122 are non-identical. A scaling factor of 1.05 between the two scans would match the two traces 121 and 122, and would correspond to a 5% difference in glass thickness, or 9 μm. This issue may be addressed in different ways. It would be possible, for example, to automate a background subtraction routine as part of the PXRD protocol.

A composition study was also performed using the 0.18 mm plate. Samples with different compositions of N₁ and H₀ were studied. FIG. 13 shows a graph 130 comparing cells A12, A1 and A9, represented respectively by traces 131, 132, and 133. Cell A12 (trace 131) contains a pure sample of the H₀ form of Aripiprazole, cell A1 (trace 132) contains a pure sample of the N₁ form, and cell A9 (trace 133) contains a 50% mixture of the N₁ and H₀ forms. All of the peaks in the N₁ and H₀ forms shown in traces 131 and 132 were accounted for in the mixture pattern 133.

FIG. 14 is a graph 140 showing the results of a composition study using the 0.25 mm plate. Different sample amounts were measured using the 500 μm monocap. Traces 141-145 show, respectively, the results obtained from testing 2 mg, 1 mg, 0.5 mg, 0.25 mg, and 0.1 mg samples of N₁. The minimum amount for acceptable intensity again appears to be 0.25 mg (trace 144). The weaker intensity for the 0.5 mg sample (trace 143) compared to the 0.25 mg sample (trace 144) was apparently due to the dispersion of the API in the 0.5 mg well during solvent evaporation. This dispersion resulted in a thinner film in the 0.5 mg well than in the 0.25 mg well.

FIG. 15 shows a graph 150 setting forth a comparison between the 0.18 mm, 0.25 mm, and 0.37 mm plates, using the 500 μm monocap. Upper trace 151 corresponds to the 0.18 mm plate, middle trace 152 corresponds to the 0.25 mm plate, and lower trace 153 corresponds to the 0.37 mm plate. Overall, it will be seen that the 0.18 mm and 0.25 mm plates display significantly greater intensity than the 0.37 mm plate. Switching from the 0.18 mm plate to the 0.25 mm plate results in approximately 19% decrease in intensity. However, this intensity loss is compensated by the increase in individual well volume from 41 μL for the 0.18 mm plate to 72 μL for the 0.25 mm plate, which will allow the 0.25 mm plate to be used with compounds with poor solubility.

To summarize the above analyses, the optimal configuration of the Bruker diffractometer was attained by inverting the radiation source so that the source was from the top of the instrument in order to eliminate shading. The best combination of intensity of resolution was achieved with the 500 μm monocap and sample-to-detector distance of 15 cm. Acceptable PXRD patterns were collected with both the 0.18 mm and 0.25 mm plates, with as little as 0.25 mg of sample in each well. Although about 19% intensity was lost going from the 0.18 mm to the 0.25 mm plate, the 0.25 mm plate may be desirable for certain processes because of its larger volume and well opening. To increase the well volume for compounds with poor solubility, it may be useful to modify the 0.25 mm plate to have a different height, such as 8 mm or 9 mm. The plate also could be used to detect mixtures of two polymorphs with acceptable resolution and intensity.

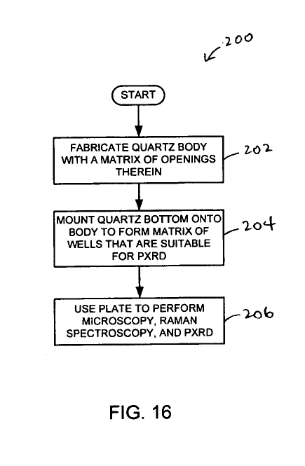

FIG. 16 shows a flowchart of a method 200 according to the present invention. In step 202, a quartz body is fabricated, having a matrix of openings therein. In step 204, a quartz sheet is mounted onto the bottom of the body to form a matrix of wells that are suitable for PXRD. In step 205, the plate is used to perform tests on the sample. These tests may include, in addition to PXRD, microscopy and Raman spectroscopy.

A further aspect of the invention provides an improved technique for analyzing slurries produced during crystallization. In prior art techniques, it was typically necessary at some point to transfer slurry samples between different holders in order to be able to perform microscopy, Raman spectroscopy, and PXRD on those samples. As described below, the present aspect of the invention eliminates this need to transfer samples.

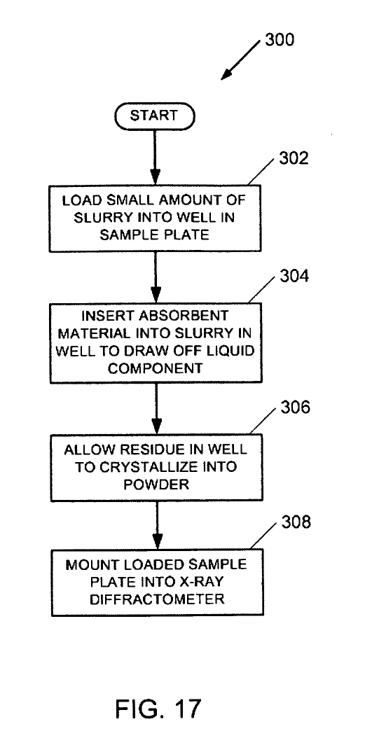

According to the present aspect of the invention, HTC screening is performed directly on a 96-well plate, such as the plate 10 shown in FIGS. 1 through 3, discussed above. FIG. 17 is a flowchart 300 showing a method according to this aspect of the invention. In step 302, samples of API are added to the wells of the sample plate, together with counter ions for salt screening and a desired solvent or solvents. In step 304, the samples are allowed to age for a certain period, typically ranging from 2 hours to 2 days. Some wells may generate a slurry, which means that in those wells, either crystals or amorphous solids have formed. In step 306, this finding is confirmed by taking microscopic images of the plate. In step 308, the remaining solvent or solvents are removed. A long strip of absorbent material, 8 strips per row, is used to remove remaining solvents directly from the plate without any transferring of the products. Suitable absorbent materials include filter paper, laboratory paper, and the like. In step 310, the remaining solids are further analyzed by taking Raman spectra to determine whether they contain potentially different forms of API. In step 312, PXRD is used to further confirm the solids. The method 300, or variations thereof, may also be applied to slurry studies, which are commonly done to study relative stability and transition point of solvate. Again, there will be no transferring of samples.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A laboratory sample plate, comprising:
a quartz body having substantially planar top and bottom surfaces that are parallel with each other, the quartz body including a matrix of cylindrical apertures that are substantially perpendicular to the top and bottom surfaces, each aperture having an upper opening at the top surface and a lower opening at the bottom surface;
a quartz bottom sheet fused to the bottom surface of the quartz body, the quartz bottom sheet including respective portions that close the lower opening of each aperture in the quartz body, such that each aperture and respective portion of the bottom sheet together form a well for receiving a sample, each aperture and respective portion of the bottom sheet being suitably dimensioned to perform a powder X-ray diffraction technique on a sample contained in the well.

2. The plate of claim 1, wherein the bottom sheet has a thickness of at most 0.37 mm and the well has a diameter of at most 6 mm.

3. The plate of claim 1, wherein the bottom sheet has a thickness of at most 0.25 mm and the well has a diameter of at most 4 mm.

4. The plate of claim 1, wherein the bottom sheet has a thickness of at most 0.18 mm and the well has a diameter of at most 3 mm.

5. The plate of claim 1, wherein the wells are suitably dimensioned to perform microscopy, Raman spectroscopy, and powder X-ray diffraction techniques to be performed on samples contained in the wells.

6. The plate of claim 1, wherein the wells are suitably dimensioned to perform PXRD on slurry samples contained in the wells.

7. A method for testing a sample, comprising the steps of:
(a) fabricating a quartz body having substantially planar top and bottom surfaces that are parallel with each other, the quartz body including a matrix of cylindrical apertures that are substantially perpendicular to the top and bottom surfaces, each aperture in the matrix having an upper opening at the top surface of the quartz body and a lower opening at the bottom surface of the quartz body;
(b) fusing a quartz bottom sheet to the bottom surface of the quartz body, the quartz bottom sheet including respective portions that close the lower openings of the apertures in the quartz body, such that each aperture and a respective portion of the bottom sheet together form a well for receiving a sample, each aperture and respective portion of the bottom sheet being suitably dimensioned to perform a powder X-ray diffraction technique on a sample contained in the well;
(c) loading a sample into at least one well in the matrix of wells; and
(d) performing a powder X-ray diffraction technique on the sample.

8. The method of claim 7, wherein in step (b), the bottom sheet has a thickness of at most 0.38 mm and each aperture has a diameter of at most 6 mm.

9. The method of claim 7, wherein in step (b), the bottom sheet has a thickness of at most 0.25 mm and each aperture has a diameter of at most 4 mm.

10. The method of claim 7, wherein in step (b), the bottom sheet has a thickness of at most 0.18 mm and each aperture has a diameter of at most 3 mm.

11. The method of claim 7, wherein step (d) includes:
performing microscopy, Raman spectroscopy, and powder X-ray diffraction techniques on samples contained in the wells.

12. The method of claim 7, wherein step (e) includes:
performing powder X-ray diffraction on slurry samples contained in the wells.

13. A method for preparing powder samples from a slurry, comprising the steps of:
(a) adding a sample of an active pharmaceutical ingredient, counter ions, and solvent to a well in a sample plate formed from a quartz body and a quartz bottom sheet fused thereto, the well and bottom sheet being suitably dimensioned to perform a powder X-ray diffraction technique on a sample contained in the well;
(b) allowing the sample to age, thereby allowing a slurry to be generated;
(c) taking a microscopic image of the plate;
(d) removing remaining solvent;
(e) taking Raman spectra to determine whether remaining solids contain potentially different forms of active pharmaceutical ingredient; and
(f) using powder X-ray diffraction to further confirm the remaining solids.

14. The method of claim 13, wherein in step (d) the remaining solvent is removed by inserting an absorbent material into the slurry in the well.

15. The method of claim 14, wherein the absorbent material comprises a strip of filter paper.
